(19) United States
(12) Patent Application Publication
(10) Pub. No.: US 2024/0202669 A1
(43) Pub. Date: Jun. 20, 2024

(54) MOBILE APPLICATION FOR OPERATIONAL CHECKS

(71) Applicant: Chevron U.S.A. Inc., San Ramon, CA (US)

(72) Inventors: Andrew James Wilson, Spring, TX (US); Aleisha Nichole Guiler, Houston, TX (US)

(21) Appl. No.: 18/068,284

(22) Filed: Dec. 19, 2022

(51) Int. Cl. G06Q 10/20

(52) U.S. Cl. CPC G06Q 10/20

(57) ABSTRACT

A mobile application is provided to standardize, streamline, and automate checklists for upstream oil and gas operations on operational assets. The mobile application presents a graphical user interface that enables a user to verify, comment on, or mark as being not applicable individual operational checks for an asset. The mobile application enables operational checks to be performed on mobile devices with or without Internet connection. The mobile application provides an efficient, reliable, and consistent processes to perform operational checks across multiple users/teams and enables collaboration among different users/teams/companies.

### FIELD

The present disclosure relates generally to the field of facilitating operational checks.

### BACKGROUND

Performing operational checks during oil and gas upstream operations (e.g., drilling, completions, workover and facilities execution) may be critical to the safety of personnel on the asset and the efficiency of operations on the asset. Use of multiple/different solutions for tracking operational checks may be inefficient, prone to error, and make communication between personnel difficult.

### SUMMARY

This disclosure relates to operational checks. Asset operational check information and/or other information may be obtained. The asset operational check information may define a list of operational checks for an asset. A graphical user interface may be presented on an electronic display. The graphical user interface may include interface elements. The interface elements may include an operational check element for individual operational checks in the list of operational checks for the asset. The operational check element may include a verification element that enables a user to verify completion of a given operational check, an add note element that enables the user to add a note to the given operational check, a not-applicable element that enables the user to mark the given operational check as being not applicable to the operational checks for the asset and skip the given operational check, and/or other elements.

A system for facilitating operational checks may include one or more electronic storage, one or more electronic displays, one or more processors and/or other components. The electronic storage may store asset operational check information, information relating to an asset, information relating to operational checks for the asset, information relating to lists of operational checks for the asset, information relating to graphical user interface, information relating to verification of operational checks, information relating to users, information relating to communications to users, information relating to acknowledge of the communications by the users, and/or other information.

The processor(s) may be configured by machine-readable instructions. Executing the machine-readable instructions may cause the processor(s) to facilitate operational checks. The machine-readable instructions may include one or more computer program components. The computer program components may include one or more of an asset operational check component, a graphical user interface component, and/or other computer program components.

The asset operational check component may be configured to obtain asset operational check information and/or other information. The asset operational check information may define one or more lists of operational checks for an asset. In some implementations, the asset may include one or more wells.

In some implementations, the asset operational check information may be obtained from a database before arrival of the user at the asset. The asset may lack Internet connection. User interaction with a graphical user interface to perform the operational checks may be recorded without Internet connection. The operational checks performed by the user without Internet connection may be synchronized with the database after Internet connection is restored.

In some implementations, the asset operational check information may be obtained from a database. The asset operational check information in the database may be updated in real time to define one or more revised lists of operational checks for the asset. The updated asset operation check information may be propagated from the database to multiple computing devices for use in performing the operational checks.

The graphical user interface component may be configured to effectuate presentation of one or more graphical user interfaces on the electronic display(s). The graphical user interface(s) may include interface elements. The interface elements may include an operational check element for individual operational checks in the list of operational checks for the asset. The operational check element may include a verification element that enables a user to verify completion of a given operational check, an add note element that enables the user to add a note to the given operational check, a not-applicable element that enables the user to mark the given operational check as being not applicable to the operational checks for the asset and skip the given operational check, and/or other elements.

In some implementations, the verification element may enable the user to verify completion of the given operational check by making a swipe motion on the verification element. In some implementations, the verification element may enable the user to verify completion of the given operational check by entering a comment on the given operational check. In some implementations, the verification element may enable the user to verify completion of the given operational check by selecting from a list of selectable options for the given operational check.

In some implementations, responsive to verification by the user of the given operational check, identity of the user, location of the user, timing of the verification by the user, and/or other information may be recorded. In some implementations, the location of the user may be obtained from a profile of the user.

In some implementations, the interface elements may include a summary element. The summary element may provide a number of pending operational checks, a number of verified operational checks, a number of operational checks marked as being not applicable, and a total number of operational checks.

In some implementations, the interface elements may further include a notification element. The notification element may enable a user to view one or more notifications for the operational checks.

In some implementations, communication including information for the asset and/or one or more directions for the asset may be transmitted to a group of users. The group of users may include the user. The interface elements may further include an acknowledgement element that enables the user to acknowledge the communication. The acknowledgement of the communication may include receipt of the information for the asset and/or implementation of the direction(s) for the asset. Responsive to acknowledgement by the user of the communication, identity of the user, location of the user, timing of the acknowledgement by the user, and/or other information may be recorded.

In some implementations, one or more gaps and/or one or more trends of user acknowledgement of the communication may be determined in real time based on recordation of the identity of the user, the location of the user, the timing of the acknowledgement by the user, and/or other information.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a,” “an,” and “the” include plural referents unless the context clearly dictates otherwise.

### BRIEF DESCRIPTION OF THE DRAWINGS

FIG. 1 illustrates an example system for facilitating operational checks.

FIG. 2 illustrates an example method for facilitating operational checks.

FIG. 3A illustrates an example scenario for facilitating operational checks.

FIG. 3B illustrates an example scenario for facilitating operational checks.

FIG. 4 illustrates an example graphical user interface.

FIG. 5 illustrates example operational check elements.

### DETAILED DESCRIPTION

The present disclosure relates to facilitating operational checks. A mobile application is provided to standardize, streamline, and automate checklists for upstream oil and gas operations on operational assets. The mobile application presents a graphical user interface that enables a user to verify, comment on, or mark as being not applicable individual operational checks for an asset. The mobile application enables operational checks to be performed on mobile devices with or without Internet connection. The mobile application provides an efficient, reliable, and consistent processes to perform operational checks across multiple users/teams and enables collaboration among different users/teams/companies.

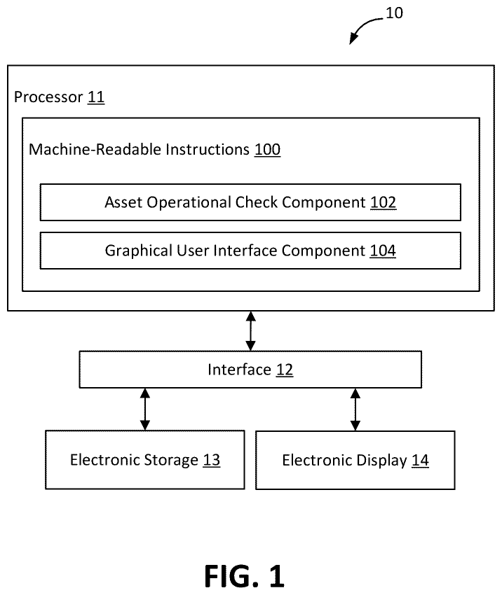

The methods and systems of the present disclosure may be implemented by a system and/or in a system, such as a system 10 shown in FIG. 1. The system 10 may include one or more of a processor 11, an interface 12 (e.g., bus, wireless interface), an electronic storage 13, an electronic display 14, and/or other components. Asset operational check information and/or other information may be obtained by the processor 11. The asset operational check information may define a list of operational checks for an asset. A graphical user interface may be presented on the electronic display 14 by the processor 11. The graphical user interface may include interface elements. The interface elements may include an operational check element for individual operational checks in the list of operational checks for the asset. The operational check element may include a verification element that enables a user to verify completion of a given operational check, an add note element that enables the user to add a note to the given operational check, a not-applicable element that enables the user to mark the given operational check as being not applicable to the operational checks for the asset and skip the given operational check, and/or other elements.

The electronic storage 13 may be configured to include electronic storage medium that electronically stores information. The electronic storage 13 may store software algorithms, information determined by the processor 11, information received remotely, and/or other information that enables the system 10 to function properly. For example, the electronic storage 13 may store asset operational check information, information relating to an asset, information relating to operational checks for the asset, information relating to lists of operational checks for the asset, information relating to graphical user interface, information relating to verification of operational checks, information relating to users, information relating to communications to users, information relating to acknowledge of the communications by the users, and/or other information.

The electronic display 14 may refer to an electronic device that provides visual presentation of information. The electronic display 14 may include a color display and/or a non-color display. In some implementations, the electronic display 14 may include a touchscreen display. The electronic display 14 may be configured to visually present information. The electronic display 14 may present information using/within one or more graphical user interfaces. For example, the electronic display 14 may present asset operational check information, information relating to an asset, information relating to operational checks for the asset, information relating to lists of operational checks for the asset, information relating to graphical user interface, information relating to verification of operational checks, information relating to users, information relating to communications to users, information relating to acknowledge of the communications by the users, and/or other information.

An asset may refer to a thing, a place, an environment, a material, a resource that is of value. An asset may include facilities, equipment, and/or personnel to extract materials, resources, and/or other things of value from the asset. For example, an asset may include a reservoir, and hydrocarbon operations (e.g., drilling, completions, workover and facilities execution) may be performed by personnel at a facility on the reservoir using equipment (e.g., drilling, extraction, transport, containment equipment). In some implementations, an asset may include one or more wells.

Operational checks may be performed to ensure that the facility and/or the equipment on the asset is performing properly. An operational check may refer to a task to determine that an item is fulfilling its intended purpose. An operational check may cover one or more parts of the item or the entirety of the item. An operational check may cover one or more functions of the time or all functions of the item. A list of operational checks may be used to ensure that an item is fulfilling its intended purpose. A list of operational checks for a piece of equipment may include multiple operational checks to ensure that different components of the piece of equipment are fulfilling their intended purposes. For example, a list of operational checks for a well may include multiple operational checks to ensure that different pieces of equipment and/or different components of equipment at the well are fulfilling their intended purposes.

Performing operational checks for the asset may be critical to ensure safety of personnel on the asset as well as proper and efficient operations on the asset. For example, carrying out operational checks in well operations may be required to make sure that safeguards are in place and functioning, and to ensure that drilling of wells and extraction of hydrocarbons are performed effectively and efficiently. Use of multiple/different solutions for tracking operational checks may be inefficient, prone to error, and make communication between personnel difficult.

The present disclosure provides a tool to facilitate operational checks for an asset. A mobile application may be executed on mobile devices, such as smartphones, tablets, smartwatches, and/or laptops, to present checklists for an asset and enable performance of checklists for the asset. In some implementations, the mobile application may be executed on desktop devices (e.g., desktop PC).

The mobile application may enable tracking of when, where, and by whom operational checks are performed. The mobile application may enable important/critical communications for the asset to be received and acknowledged by personnel. The mobile application may enable verification and validation of such communication in the field. The mobile application may enable tracking of when, where, and by whom such communications are acknowledged. The mobile application may standardize, streamline, and automate checklists for the asset. The mobile application may enable online and offline verification of operational check completion. When the mobile application is offline, a notification of offline status may be presented to users. The users may be required to confirm the offline status notification to clear the notification and/or before working on a checklist. Changes made to the checklist may be automatically synchronized when the mobile application is online.

The mobile application may enable personnel within a company and personnel across different companies to collaborate in carrying out and verifying operational checks on the asset. For example, the mobile application may enable drill site representatives and/or well site representative for a company to collaborate with third parties (e.g., equipment representatives) that support the company's operations in carrying out and verifying operational checks on an asset.

The mobile application may provide different functionalities to different types of users. For example, a user may be presented with checklists relevant to their job and/or the operational checks for which they are responsible. The mobile application may enable users in different roles and/or from different organizations to work from the same checklist to verify operational checks that are relevant for their roles. The mobile application may enable users to search for and/or filter out checklists. The mobile application may enable users to utilize current/pending checklists. The mobile application may enable users to see historical/completed checklists. Other functionalities of the mobile application are contemplated.

Referring back to FIG. 1, the processor 11 may be configured to provide information processing capabilities in the system 10. As such, the processor 11 may comprise one or more of a digital processor, an analog processor, a digital circuit designed to process information, a central processing unit, a graphics processing unit, a microcontroller, an analog circuit designed to process information, a state machine, and/or other mechanisms for electronically processing information. The processor 11 may be configured to execute one or more machine-readable instructions 100 to facilitate operational checks. The machine-readable instructions 100 may include one or more computer program components. The machine-readable instructions 100 may include an asset operational check component 102, a graphical user interface component 104, and/or other computer program components.

The asset operational check component 102 may be configured to obtain asset operational check information and/or other information. Obtaining asset operational check information may include one or more of accessing, acquiring, analyzing, determining, examining, generating, identifying, loading, locating, opening, receiving, retrieving, reviewing, selecting, storing, and/or otherwise obtaining the asset operational check information. The asset operational check component 102 may obtain asset operational check information from one or more locations. For example, the asset operational check component 102 may obtain asset operational check information from a storage location, such as the electronic storage 13, electronic storage of a device accessible via a network, and/or other locations. The asset operational check component 102 may obtain asset operational check information from one or more hardware components (e.g., a computing device, a server) and/or one or more software components (e.g., software running on a computing device).

The asset operational check information may define one or more lists of operational checks for an asset. A list of operational checks for an asset may be referred to as a checklist. A list of operational checks for an asset may include multiple operational checks for the asset. A list of operational check for an asset may be specific to one or more facilities, equipment, and/or other things at the asset. Different lists of operational checks may exist for different facilities, different equipment, and/or different things at the asset. A list of operational check for an asset may be specific to one or more users/personnel at the asset. Different lists of operational checks may exist for different users/personnel at the asset. In some implementations, particular asset operational check information may be obtained based on identity/role of the user, location of the user, time at which the asset operational check information is obtained, and/or other information.

The asset operational check information may define a list of operational checks for an asset by characterizing, describing, identifying, reflecting, setting forth, and/or otherwise defining the list of operational checks for the asset. The asset operational check information may define a list of operational checks for an asset by including information that defines content, attributes, features, and/or other aspects of the list of operational checks for the asset. For example, the asset operational check information may define a list of operational checks for an asset by including information that specifies the operational checks in the list and specifics of the operational checks in the list. Other types of asset operational check information are contemplated.

In some implementations, the asset operational check information may be obtained from a database. A database may refer to a structured set of data held in one or more computing devices. A database may store asset operational check information for an asset and/or other information relating to the asset. A database may be held in a computing device local to the system 10 and/or remote from the system 10.

In some implementations, the asset operational check information may be obtained from a database for a user before arrival of the user at the asset. For example, the asset operational check information may be downloaded from a database to a mobile device of a user before the user travels to the asset. The asset may lack Internet connection. The user may interact with the mobile device in offline mode to perform operational checks. User interaction with the mobile device (e.g., user interaction with a graphical user interface presented on an electronic display of the mobile device) to perform the operational checks may be recorded without Internet connection. The operational checks performed by the user without Internet connection may be synchronized with the database after Internet connection is restored. The graphical user interface may present information relating to offline usage. For example, the graphical user interface may show whether or not changes in performance of operational checks have been synchronized with the database. The graphical user interface may show when synchronization with the database was last performed (e.g., data and time of last synchronization).

In some implementations, the asset operational check information in a database may be updated (e.g., changed, modified) in real time to define one or more revised lists of operational checks for the asset. The updated asset operation check information may be propagated from the database to multiple computing devices for use in performing the operational checks. For example, certain users (e.g., administrators, power users) may have privileges to change lists of operational checks stored in the database. These users may make changes to the lists and the changed lists may be transmitted/pushed from the database to relevant assets, teams, facilities, and/or users.

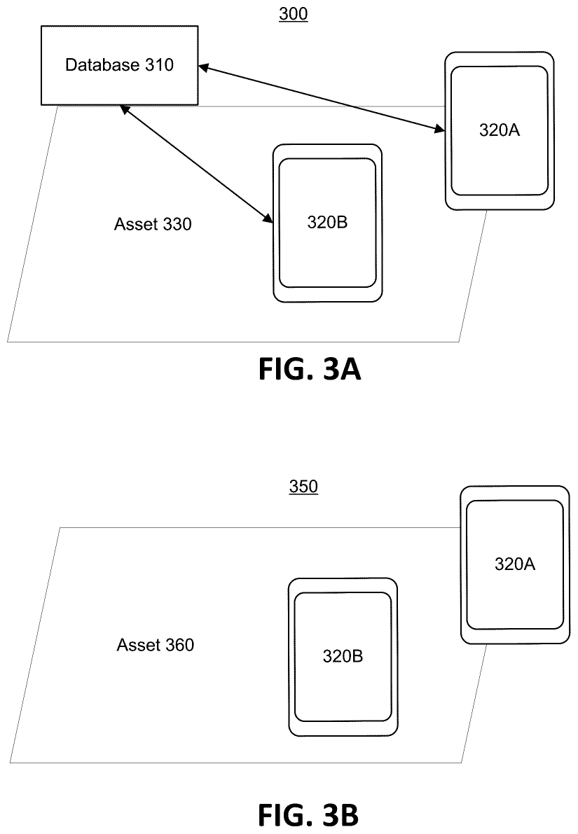

FIG. 3A illustrates an example scenario 300 for facilitating operational checks. In the scenario 300, a database 310 may store lists of operational check for an asset 330. Same or different lists of operational checks for the asset 300 may be downloaded to mobile devices 320A, 320B. The mobile devices 320A, 320B may present operational checks in the list(s) of operational checks within a graphical user interface and enable the users of the mobile devices 320A, 320B to verify completion of operational checks for the asset 330.

The database 310 and the mobile devices 320A, 320B may maintain communication while the users perform the operational checks. Completion of operational checks may be updated in real time and/or periodically. Completion of operational checks verified through the mobile devices 320A, 320B may be transmitted to the database when the completion is verified and/or periodically. Changes to lists of operational checks at the database 310 may be pushed to the mobile devices 320A, 320B so that the users of the mobile devices 320A, 320B are working from the latest version of the lists.

FIG. 3B illustrates an example scenario 350 for facilitating operational checks. In the scenario 350, same or different lists of operational checks for an asset 360 may be downloaded from a database to the mobile devices 320A, 320B before the mobile devices 320A, 320B arrive at the asset 360. The mobile devices 320A, 320B may present operational checks in the list(s) of operational checks within a graphical user interface and enable the users of the mobile devices 320A, 320B to verify completion of operational checks for the asset 360. When the mobile devices 320A, 320B establishes communication with the database, the verification of operational check completion entered on the mobile devices 320A, 320B may be synchronized with the database.

The graphical user interface component 104 may be configured to effectuate presentation of one or more graphical user interfaces on the electronic display 14 and/or other electronic display(s). Effectuating presentation of a graphical user interface on an electronic display may include causing, bringing about, facilitating, and/or otherwise effectuating presentation of the graphical user interface on the electronic display.

A graphical user interface may refer to a user interface that enables a user to interact with the system 10 through one or more interface elements. A graphical user interface may refer to a user interface that enables the system 10 to provide information to a user through one or more interface elements. A graphical user interface may include interface elements. A graphical user interface may be static or dynamic. A graphical user interface may include a static configuration of interface elements and/or include dynamic configurations of interface elements that changes (e.g., with time, based on user interaction with one or more interface elements). Multiple/different interface elements may be presented/included within a graphical user interface at the same time, may be presented/included within a graphical user interface at different times, and/or may be presented/included within a graphical user interface responsive to user interaction with one or more other interface elements and/or other information.

An interface element of a graphical user interface may refer to a graphical element of the graphical user interface, such as window, icon, button, graphic, and/or other visual indicator. An interface element may include multiple, smaller interface elements. An interface element may visually provide information and/or enable a user to provide inputs to the system 10. For example, an interface element may visually provide information determined by the system 10 and/or a user may interact (e.g., engage, toggle, manipulate) with an interface element to provide one or more input to the system 10. A graphical user interface may facilitate interaction of the user with one or more of the interface elements via the user input received through one or more user interface devices (e.g., touchscreen display, keyboard, mouse, trackpad) and/or other user input. For example, a graphical user interface may present/include the interface elements in a particular arrangement and enable the user to interact with individual interface elements by engaging with locations corresponding to the individual interface elements on a touchscreen display.

The interface elements may include an operational check element and/or other interface element. An operational check element may define a section/area within the graphical user interface for a particular operational check. An operational check element may exist for individual operational checks in the list of operational checks for the asset. Separate operational check elements may exist for separate operational checks in the list of operational checks for the asset. The graphical user interface may include all or some of the operational check elements at once. For example, the list of operational checks may include a few operational checks, and all operational check elements for the operational checks may be presented within the graphical user interface at once. As another example, the operational checks may include many operational checks, and operational check elements for some of the operational checks may be presented within the graphical user interface at once. The user may interact with the graphical user to see different operational check elements for different operational checks.

An operational check element may include a verification element, an add note element, a not-applicable element, and/or other interface elements. The verification element may refer to an interface element that enables a user to verify completion of an operational check. The verification element may work as a verify option in the graphical user interface. The verification element may enable a user to verify completion of an operational check via one or more interactions with the verification element and/or the graphical user interface.

For example, the verification element may enable the user to verify completion of an operational check by making a swipe motion on the verification element. A swipe motion in one direction on the verification element may result in the operational check being marked as completed, while a swipe motion in another direction (e.g., opposite direction) on the verification element may result in unmarking of the operational check as being not completed.

The verification element may enable the user to verify completion of an operational check by entering a comment on the given operational check. The user may be prompted to enter a comment relating to the operational check to verify its completion, such as a comment that adds context to the completion of the operational check, a comment that explains if the operational check was completed different, a comment that describe if things went wrong, and/or other comments. Deletion of entered comment may result in the operational check being unmarked as being not completed.

The verification element may enable the user to verify completion of an operational check by selecting from a list of selectable options for the operational check. The selectable options may be predefined for the operational check, and the user may be required to select one or more of the selectable options to verify completion of the operational check. Removal of user selection may result in the operational check being unmarked as being not completed.

The add note element may refer to an interface element that enables a user to add a note to an operational check. The add note element may work as an add note option in the graphical user interface. Responsive to user interaction with the add note element, the graphical user interface may prompt the user to enter one or more notes to the operational check. The user may enter one or more notes to provide information about the operational check, such as description of the operational check, explanation of any changes in the operational check, explanation of why an operational check was not performed, and/or other information relating to the operational check. Notes entered for an operational check may be visible in the operational check element. Responsive to a note being entered for an operational check, the add note element may be changed into a different interface element (e.g., a note added element that visually indicates that a note has been added; an edit note element that enables a user to edit an entered note; a show note element that enables a user to see an entered note).

The not-applicable element may refer to an interface element that enables a user to mark an operational check as being not applicable to the operational checks for the asset and skip the operational check. The not-applicable element may work as a mark N/A option in the graphical user interface. Responsive to user interaction with the not-applicable element, the operational check may be made inactive. Responsive to user interaction with the not-applicable element, the user may move onto other operational checks without verifying completion of the operational check.

In some implementations, a swipe motion may be required to verify completion of an operational check, to add a note to an operational check, and/or to mark an operational check as being not applicable. For example, after a user has entered a comment or selected an option, the user may be required to make a swipe motion to finalize the comment or the selected option. In some implementations, a swipe motion may be required to remove completion verification of an operational check. For example, a user may not be allowed to delete an entered comment or remove a selected option without making a swipe motion in the opposite direction. After making the swipe motion in the opposite direction, the user may be allowed to delete an entered comment or remove a selected option. Making the swipe motion in the opposite direction may cause the entered comment to be deleted or a selected option to be removed.

In some implementations, responsive to a user completion of all operational checks assigned to the user, the graphical user may present a notification that all assigned operational checks for a list has been completed. The completion of the assigned operational checks by the user may be automatically communicated to other users (e.g., other members of the team).

In some implementations, the interface elements may include a summary element. The summary element may provide summary information relating to operational checks. The summary element may provide information relating to status and/or number of operational checks. For example, the summary element provide a number of pending operational checks, a number of verified operational checks, a number of operational checks marked as being not applicable, a total number of operational checks, and/or other information relating to the operational checks. The summary element may enable a user (e.g., personnel, supervisor, representative) to easily check how many operational checks are pending, how many operational checks have been performed, and how many operational checks have been as being not applicable. The summary element may provide a breakdown of operational checks based on the type of personnel to which the operational checks have been assigned. For example, the summary element may include a listing of different types of personnel (e.g., drill site representative, drilling contractor, BOP tester, etc.), the number of operational checks assigned to the different types of personnel, and the number of operational checks verified as being completed.

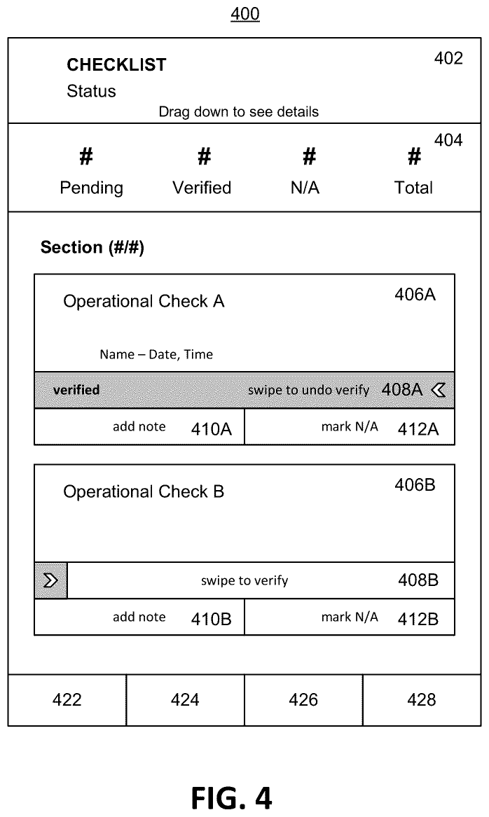

FIG. 4 illustrates an example graphical user interface 400. The view of the graphical user interface in FIG. 4 is provided merely as an example, and the arrangement and visual aspects of the graphical user interface may vary depending on the implementation. In some implementations, the graphical user interface may include additional features and/or alternative features. In some implementations, the graphical user interface may not include features shown in FIG. 4. Other graphical user interfaces are contemplated.

The graphical user interface 400 may include a title element 402, a summary element 404, operational check elements 406A, 406B, button elements 422, 424, 426, 428, and/or other interface elements. The title element 402 may provide information relating to a list of operational checks, such as the name of the list, status of the list (e.g., when the list was created, when the list was synchronized), and/or other information relating to the list. The title element 402 may initially present basic information about the list while hiding more detailed information about list. The user may see more detailed information about the list by interacting with the title element 402, such as by dragging down on the title element 402.

The summary element 404 may provide summary information relating to the list of operational checks. For example, the summary element 404 provide a number of pending operational checks, a number of verified operational checks, a number of operational checks marked as being not applicable, a total number of operational checks, and/or other information relating to the operational checks.

The graphical user interface 400 may group operational check elements by sections. For example, the graphical user interface 400 may group operational check elements by sections of a wellbore and enable a user to review all operational checks related to a specific section of the wellbore within a corresponding wellbore section of the graphical user interface 400. The graphical user interface 400 may provide information on the number of operational checks completed for a section, the number of operational checks to be completed for the section, the total number of operational checks for the section, and/or other information on the operational checks for the section.

The graphical user interface 400 may include separate operational check elements for separate operational checks. For example, in FIG. 4, the graphical user interface 400 may include the operational check element 406A for an operational check A and the operational check element 406B for an operational check B. The operational check element 406A may show that the completion of the operational check A has been verified in a verification section 408A. A user may swipe along the verification section in one direction (e.g., to the left) to undo the verification. The operational check element 406A may show information relating to verification/completion of the operational check A, such as the name of the person that verified the completion of the operational check A, as well as the data and time that the completion of the operational check A was verified. The operational check element 406A may include an add note element 410A that enables the user to add a note to the operational check A, and a not-applicable element 412A that enables the user to mark the operational check A as being not applicable to the operational checks for the asset and skip the operational check A.

The operational check element 406B may show that the completion of the operational check B has not yet been verified in a verification section 408B. A user may swipe along the verification section in one direction (e.g., to the right) to verify the completion of the operational check B. The operational check element 406B may include an add note element 410B that enables the user to add a note to the operational check B, and a not-applicable element 412B that enables the user to mark the operational check B as being not applicable to the operational checks for the asset and skip the operational check B.

In some implementations, one or more visual characteristics of the operational check elements based on whether or not the corresponding operational check has been verified as being completed. For example, the color of the operational check elements may change based on whether or not the corresponding operational check has been verified as being completed. Other changes in visual characteristics of the operational check elements are contemplated.

The button elements 422, 424, 426, 428 may provide/facilitate other functionalities of the graphical user interface 400. For example, the button element 422 may include a checklists button element. The checklists button element may enable a user to see a sling of checklists for an asset. Responsive to user interaction with the button element 422, the graphical user interface 400 may change to present the listing of checklists for the asset.

The button element 424 may include new checklist button element. The new checklist button element may enable a user to create a new checklist. Responsive to user interaction with the button element 424, the graphical user interface 400 may change to enable the user to create a new checklist.

The button element 426 may include a notification element. The notification element may enable a user to view one or more notifications for the operational checks. Responsive to user interaction with the button element 426, the graphical user interface 400 may change to show notifications relating to the checklists (e.g., a list of important/critical communications for the asset to be received and acknowledged by the user. The button element 426 may provide information on presence of and/or number of notifications that have not yet been seen/acknowledged by the user. In some implementations, notifications may be grouped into different sections or tabs. For example, notifications for important/critical communications for the asset to be received and acknowledged by the user may be presented within one tab of notification while notifications for checklist activity (e.g., completion of checklists/operational checks) may be presented within another tab of notification.

The button element 428 may include a profile element. The profile element may enable user to see and/or change the user's profile. Responsive to user interaction with the button element 428, the graphical user interface may change to show the profile of the user and/or enable the user to change information on the profile of the user. Other types of button elements are contemplated.

The graphical user interface 400 may present other information relating to the operational checks. For example, the graphical user interface 400 may present information that may be helpful for completing the operational checks. For instance, the graphical user interface 400 may present guidance/caution notes for completing the operational checks. The guidance/caution note(s) for an operational check may be presented before/adjacent to the operational check element for the operational check. The guidance/caution note(s) may be presented differently (e.g., in different color) than the operational checks.

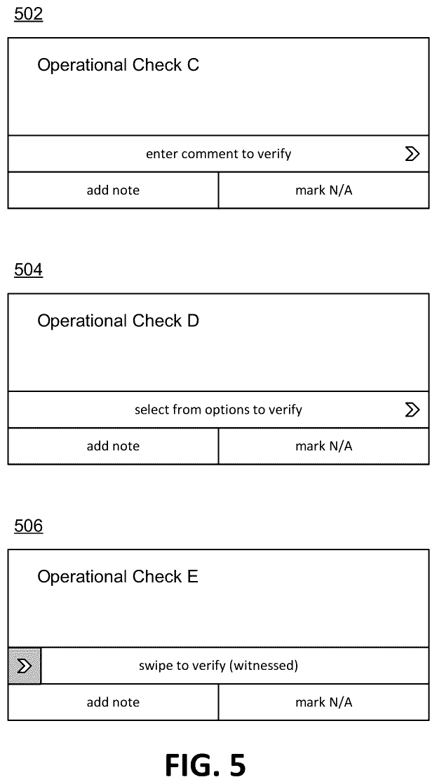

While the operational check elements 406A, 406B are shown in FIG. 4 as receiving user interaction through swipe motion, this is merely as an example and is not meant to be limiting. The operational check elements may enable/require other user interaction for operational checks. Other examples of user interaction are shown in FIG. 5.

FIG. 5 illustrates example operational check elements 502, 504, 506. The views of the operational check element in FIG. 5 are provided merely as examples, and the arrangement and visual aspects of the operational check element may vary depending on the implementation. In some implementations, the operational check element may include additional features and/or alternative features. In some implementations, the operational check element may not include features shown in FIG. 5. Other operational check elements are contemplated.

In the operational check element C 502, a user may enter a comment to verify completion of an operational check C. The user may be required to use a swipe to enter the comment and/or to finalize the comment. For example, before the comment can be added for the operational check C, the user may be required to swipe in one direction (e.g., to the right). Once the comment has been entered for the operational check C, the user may be required to swipe in one direction to finalize the comment. The user may remove the comment to undo the verification. For example, the user may remove the comment for the operational check C by swiping in another direction (e.g., to the left).

In the operational check element D 504, a user may select one or more options from a list of selectable options to verify completion of an operational check D. The user may be required to use a swipe to make the selection and/or to finalize the selection. For example, before the user can make the selection, the user may be required to swipe in one direction (e.g., to the right). Once the selection has been made for the operational check D, the user may be required to swipe in one direction to finalize the selection. The user may remove the selection to undo the verification. For example, the user may remove the selection for the operational check D by swiping in another direction (e.g., to the left).

In the operational check element E 506, a user may swipe to verify completion of an operational check E, with the completion witnessed by one or more persons. The user may be required to enter information on the person(s) that witnessed the completion, such as the name and/or the role of the person(s) and/or the company at which the person(s) work. In some implementations, the person(s) that witnessed the completion of the operational check E may be required to verify witnessing the completion on their own computing devices.

In some implementations, a user marking of an operational check using the graphical user interface may conflict with another user's marking of the operational check. For example, one user may mark an operational check as being completed while another user may mark the operational check as being not applicable. Conflict in user marking of a single operational check may be identified and surfaced to one or more users. For example, the user that is marking the operational check later in time may be provided with a notification that another user has already marked the operational check/marked the operational check differently and asked to confirm whether the old marking should be overridden with the new marking. In some implementations, the later user may be required to provide reasoning for the change in marking. In some implementations, the later user may require permission/approval of the earlier user and/or another user (e.g., administrators) to override the existing marking.

In some implementations, responsive to verification by the user of an operational check, identity of the user, location of the user, timing of the verification by the user, and/or other information may be recorded. For example, the identity of the user, the location of the user, the timing of the verification by the user, and/or other information relating to the operational check may be stored/uploaded to a database. In some implementations, the location of the user may be obtained from a profile of the user. For example, the user may enter location in which the user is working in the user's profile, and this location may be used as the location at which the completion of the operation check is verified. In some implementations, the location of the user may be obtained from the computing device on which the completion of the operational check is verified. For example, the user may use a mobile device to verify completion of the operational check, and the location of the mobile device (e.g., determined based on GPS sensor of the mobile device, determined based on communication of the mobile device with other computing device(s)) may be used as the location of the user.

Information on user verification of operational check completion may be used to perform one or more analysis of the operational checks, the users, and/or the asset. For example, information on identify of the user, the location of the user, the timing of the verification by the user, and/or other information relating to the operational check may be used in analytics to increase efficiency of performing operational check and/or make performance of the operational checks safer. Information on user verification of operational check completion may be used to one or more gaps and/or one or more trends in verification of operational check completions. For example, failure to complete particular operational checks and/or average number of operational check completion (e.g., number completed in a day, a month, a year) may be determined based on the information. If safety violations and/or incidents occurred at the asset, the relevant operational checks may be identified and modified to reduce such occurrence.

As another example, information on user verification of operational check completion may be used to modify the operational checks. For instance, a trend of users working on a checklist may reveal that users are performing the checklist in a different order than as ordered in the checklist. Based on timing/sequence of how the users worked on the operational checks, the ordering of the operational check in the checklist may be changed to be consistent with usage. A trend of users working on a checklist may reveal that users are consistently adding a note to make changes to an operational check. The notes added to the operational check may be used to change the operational check and enable the users to complete the operational check with less modification. Other use of information on user verification of operational check completion is contemplated.

In some implementations, communication including information for the asset and/or one or more directions for the asset may be transmitted to a group of users. For example, certain users (e.g., administrators, power users) may have privileges to send important/critical communications for the asset to multiple users, and require the communication to be acknowledged by individual users. The graphical user interface may present such communication to the users and prompt the users to acknowledge individual communication. For example, such communication may appear within a notification section responsive to user interaction with a notification element.

The interface elements may further include an acknowledgement element that enables a user to acknowledge the communication. The acknowledgement of the communication may include receipt of the information for the asset and/or implementation of the direction(s) for the asset. The user's acknowledgement of the communication may include the user verifying that the communication has been received and/or that the direction(s) in the communication has been performed.

The graphical user interface may include an acknowledgement element for individual communication received by the user. The acknowledgement element may be same as or similar to the operational check element. For example, the acknowledge element may enable a user to acknowledge particular communication by making a swipe motion on the acknowledgement element, by entering a comment on the communication, by selecting from a list of selectable options for the communication, and/or by interacting with the acknowledgement element in other ways.

Responsive to acknowledgement by the user of the communication, identity of the user, location of the user, timing of the acknowledgement by the user, and/or other information may be recorded. For example, the identity of the user, the location of the user, the timing of the verification by the user, and/or other information relating to acknowledgement of the communication may be stored/uploaded to a database. In some implementations, the location of the user may be obtained from a profile of the user. For example, the user may enter location in which the user is working in the user's profile, and this location may be used as the location at which the communication is acknowledged by the user. In some implementations, the location of the user may be obtained from the computing device on which the communication is acknowledged. For example, the user may use a mobile device to acknowledge the communication, and the location of the mobile device (e.g., determined based on GPS sensor of the mobile device, determined based on communication of the mobile device with other computing device(s)) may be used as the location of the user.

Information on user acknowledgement of communication may be used to perform one or more analysis of the operational checks, the communication, the users, and/or the asset. For example, information on identify of the user, the location of the user, the timing of the acknowledgement by the user, and/or other information relating to the communication may be used in analytics to determine when, where, and/or by whom the communication was acknowledged. Information on user acknowledgement of communication may be used to determine one or more gaps and/or one or more trends of user acknowledgement of the communication. For example, gap(s) and/or trend(s) of user acknowledgement of the communication may be determined in real time based on recordation of the identity of the user, the location of the user, the timing of the acknowledgement by the user, and/or other information. Information on user acknowledgement of communication may enable identification of which users received and/or implemented the communication rather than assuming that the users received and/or implemented the communication.

Implementations of the disclosure may be made in hardware, firmware, software, or any suitable combination thereof. Aspects of the disclosure may be implemented as instructions stored on a machine-readable medium, which may be read and executed by one or more processors. A machine-readable medium may include any mechanism for storing or transmitting information in a form readable by a machine (e.g., a computing device). For example, a tangible computer-readable storage medium may include read-only memory, random access memory, magnetic disk storage media, optical storage media, flash memory devices, and others, and a machine-readable transmission media may include forms of propagated signals, such as carrier waves, infrared signals, digital signals, and others. Firmware, software, routines, or instructions may be described herein in terms of specific exemplary aspects and implementations of the disclosure, and performing certain actions.

In some implementations, some or all of the functionalities attributed herein to the system 10 may be provided by external resources not included in the system 10. External resources may include hosts/sources of information, computing, and/or processing and/or other providers of information, computing, and/or processing outside of the system 10.

Although the processor 11, the electronic storage 13, and the electronic display 14 are shown to be connected to the interface 12 in FIG. 1, any communication medium may be used to facilitate interaction between any components of the system 10. One or more components of the system 10 may communicate with each other through hard-wired communication, wireless communication, or both. For example, one or more components of the system 10 may communicate with each other through a network. For example, the processor 11 may wirelessly communicate with the electronic storage 13. By way of non-limiting example, wireless communication may include one or more of radio communication, Bluetooth communication, Wi-Fi communication, cellular communication, infrared communication, or other wireless communication. Other types of communications are contemplated by the present disclosure.

Although the processor 11, the electronic storage 13, and the electronic display 14 are shown in FIG. 1 as single entities, this is for illustrative purposes only. One or more of the components of the system 10 may be contained within a single device or across multiple devices. For instance, the processor 11 may comprise a plurality of processing units. These processing units may be physically located within the same device, or the processor 11 may represent processing functionality of a plurality of devices operating in coordination. The processor 11 may be separate from and/or be part of one or more components of the system 10. The processor 11 may be configured to execute one or more components by software; hardware; firmware; some combination of software, hardware, and/or firmware; and/or other mechanisms for configuring processing capabilities on the processor 11.

It should be appreciated that although computer program components are illustrated in FIG. 1 as being co-located within a single processing unit, one or more of computer program components may be located remotely from the other computer program components. While computer program components are described as performing or being configured to perform operations, computer program components may comprise instructions which may program processor 11 and/or system 10 to perform the operation.

While computer program components are described herein as being implemented via processor 11 through machine-readable instructions 100, this is merely for ease of reference and is not meant to be limiting. In some implementations, one or more functions of computer program components described herein may be implemented via hardware (e.g., dedicated chip, field-programmable gate array) rather than software. One or more functions of computer program components described herein may be software-implemented, hardware-implemented, or software and hardware-implemented.

The description of the functionality provided by the different computer program components described herein is for illustrative purposes, and is not intended to be limiting, as any of computer program components may provide more or less functionality than is described. For example, one or more of computer program components may be eliminated, and some or all of its functionality may be provided by other computer program components. As another example, processor 11 may be configured to execute one or more additional computer program components that may perform some or all of the functionality attributed to one or more of computer program components described herein.

The electronic storage media of the electronic storage 13 may be provided integrally (i.e., substantially non-removable) with one or more components of the system 10 and/or as removable storage that is connectable to one or more components of the system 10 via, for example, a port (e.g., a USB port, a Firewire port, etc.) or a drive (e.g., a disk drive, etc.). The electronic storage 13 may include one or more of optically readable storage media (e.g., optical disks, etc.), magnetically readable storage media (e.g., magnetic tape, magnetic hard drive, floppy drive, etc.), electrical charge-based storage media (e.g., EPROM, EEPROM, RAM, etc.), solid-state storage media (e.g., flash drive, etc.), and/or other electronically readable storage media. The electronic storage 13 may be a separate component within the system 10, or the electronic storage 13 may be provided integrally with one or more other components of the system 10 (e.g., the processor 11). Although the electronic storage 13 is shown in FIG. 1 as a single entity, this is for illustrative purposes only. In some implementations, the electronic storage 13 may comprise a plurality of storage units. These storage units may be physically located within the same device, or the electronic storage 13 may represent storage functionality of a plurality of devices operating in coordination.

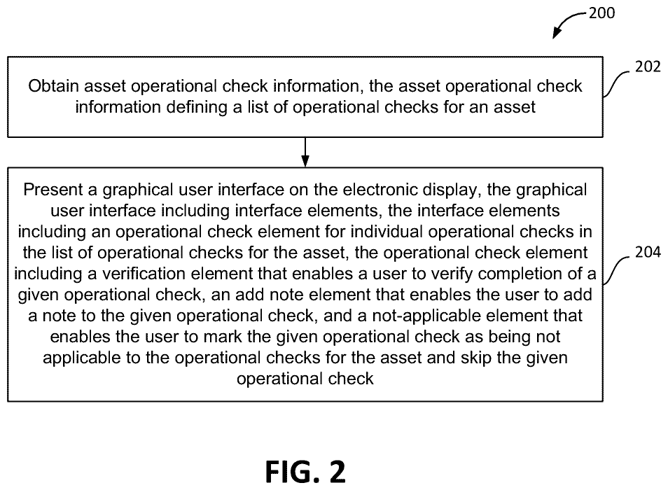

FIG. 2 illustrates method 200 for facilitating operational checks. The operations of method 200 presented below are intended to be illustrative. In some implementations, method 200 may be accomplished with one or more additional operations not described, and/or without one or more of the operations discussed. In some implementations, two or more of the operations may occur substantially simultaneously.

In some implementations, method 200 may be implemented in one or more processing devices (e.g., a digital processor, an analog processor, a digital circuit designed to process information, a central processing unit, a graphics processing unit, a microcontroller, an analog circuit designed to process information, a state machine, and/or other mechanisms for electronically processing information). The one or more processing devices may include one or more devices executing some or all of the operations of method 200 in response to instructions stored electronically on one or more electronic storage media. The one or more processing devices may include one or more devices configured through hardware, firmware, and/or software to be specifically designed for execution of one or more of the operations of method 200.

Referring to FIG. 2 and method 200, at operation 202, asset operational check information and/or other information may be obtained. The asset operational check information may define a list of operational checks for an asset. in some implementations, operation 202 may be performed by a processor component the same as or similar to the asset operational check component 102 (Shown in FIG. 1 and described herein).

At operation 204, a graphical user interface may be presented on an electronic display. The graphical user interface may include interface elements. The interface elements may include an operational check element for individual operational checks in the list of operational checks for the asset. The operational check element may include a verification element that enables a user to verify completion of a given operational check, an add note element that enables the user to add a note to the given operational check, a not-applicable element that enables the user to mark the given operational check as being not applicable to the operational checks for the asset and skip the given operational check, and/or other elements. In some implementations, operation 204 may be performed by a processor component the same as or similar to the graphical user interface component 104 (Shown in FIG. 1 and described herein).

Although the system(s) and/or method(s) of this disclosure have been described in detail for the purpose of illustration based on what is currently considered to be the most practical and preferred implementations, it is to be understood that such detail is solely for that purpose and that the disclosure is not limited to the disclosed implementations, but, on the contrary, is intended to cover modifications and equivalent arrangements that are within the spirit and scope of the appended claims. For example, it is to be understood that the present disclosure contemplates that, to the extent possible, one or more features of any implementation can be combined with one or more features of any other implementation.

What is claimed is:

1. A system for facilitating operational checks, the system comprising:
an electronic display; and
one or more physical processors configured by machine-readable instructions to:
obtain asset operational check information, the asset operational check information defining a list of operational checks for an asset; and
effectuate presentation of a graphical user interface on the electronic display, the graphical user interface including interface elements, the interface elements including an operational check element for individual operational checks in the list of operational checks for the asset, the operational check element including a verification element that enables a user to verify completion of a given operational check, an add note element that enables the user to add a note to the given operational check, and a not-applicable element that enables the user to mark the given operational check as being not applicable to the operational checks for the asset and skip the given operational check.

2. The system of claim 1, wherein the asset includes a well.

3. The system of claim 1, wherein the verification element enables the user to verify completion of the given operational check by making a swipe motion on the verification element.

4. The system of claim 1, wherein the verification element enables the user to verify completion of the given operational check by entering a comment on the given operational check.

5. The system of claim 1, wherein the verification element enables the user to verify completion of the given operational check by selecting from a list of selectable options for the given operational check.

6. The system of claim 1, wherein responsive to verification by the user of the given operational check, identity of the user, location of the user, and timing of the verification by the user are recorded.

7. The system of claim 6, wherein the location of the user is obtained from a profile of the user.

8. The system of claim 1, wherein the interface elements further include a notification element that enables a user to view one or more notifications for the operational checks.

9. The system of claim 1, wherein the interface elements further include a summary element, the summary element providing a number of pending operational checks, a number of verified operational checks, a number of operational checks marked as being not applicable, and a total number of operational checks.

10. The system of claim 1, wherein:
the asset operational check information is obtained from a database before arrival of the user at the asset;
the asset lacks Internet connection;
user interaction with the graphical user interface to perform the operational checks is recorded without Internet connection; and
the operational checks performed by the user without Internet connection is synchronized with the database after Internet connection is restored.

11. The system of claim 1, wherein:
the asset operational check information is obtained from a database;
the asset operational check information in the database is updated in real time to define a revised list of operational checks for the asset; and
the updated asset operation check information is propagated from the database to multiple computing devices for use in performing the operational checks.

12. The system of claim 1, wherein:
communication including information for the asset or a direction for the asset is transmitted to a group of users, the group of users including the user;
the interface elements further include an acknowledgement element that enables the user to acknowledge the communication, wherein the acknowledgement of the communication includes receipt of the information for the asset or implementation of the direction for the asset; and
responsive to acknowledgement by the user of the communication, identity of the user, location of the user, and timing of the acknowledgement by the user are recorded.

13. The system of claim 12, wherein a gap or a trend of user acknowledgement of the communication is determined in real time based on recordation of the identity of the user, the location of the user, and the timing of the acknowledgement by the user.

14. A method for facilitating operational checks, the method comprising:
obtaining asset operational check information, the asset operational check information defining a list of operational checks for an asset; and
effectuating presentation of a graphical user interface on an electronic display, the graphical user interface including interface elements, the interface elements including an operational check element for individual operational checks in the list of operational checks for the asset, the operational check element including a verification element that enables a user to verify completion of a given operational check, an add note element that enables the user to add a note to the given operational check, and a not-applicable element that enables the user to mark the given operational check as being not applicable to the operational checks for the asset and skip the given operational check.

15. The method of claim 14, wherein the verification element enables the user to verify completion of the given operational check by making a swipe motion on the verification element, by entering a comment on the given operational check, or by selecting from a list of selectable options for the given operational check.

16. The method of claim 14, wherein responsive to verification by the user of the given operational check, identity of the user, location of the user, and timing of the verification by the user are recorded.

17. The method of claim 14, wherein:
the asset operational check information is obtained from a database before arrival of the user at the asset;
the asset lacks Internet connection;
user interaction with the graphical user interface to perform the operational checks is recorded without Internet connection; and
the operational checks performed by the user without Internet connection is synchronized with the database after Internet connection is restored.

18. The method of claim 14, wherein:
the asset operational check information is obtained from a database;
the asset operational check information in the database is updated in real time to define a revised list of operational checks for the asset; and
the updated asset operation check information is propagated from the database to multiple computing devices for use in performing the operational checks.

19. The method of claim 14, wherein:
communication including information for the asset or a direction for the asset is transmitted to a group of users, the group of users including the user;
the interface elements further include an acknowledgement element that enables the user to acknowledge the communication, wherein the acknowledgement of the communication includes receipt of the information for the asset or implementation of the direction for the asset; and
responsive to acknowledgement by the user of the communication, identity of the user, location of the user, and timing of the acknowledgement by the user are recorded.

20. The method of claim 19, wherein a gap or a trend of user acknowledgement of the communication is determined in real time based on recordation of the identity of the user, the location of the user, and the timing of the acknowledgement by the user.
